(19) United States
(12) Patent Application Publication
(10) Pub. No.: US 2005/0178840 A1
(43) Pub. Date: Aug. 18, 2005

(54) Automatic scanning device for bar codes and method employing the same

(75) Inventors: Kuang-Yuan Chang, Tu-Cheng (TW); Xi-Lan Zou, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/025,449

(22) Filed: Dec. 29, 2004

(30) Foreign Application Priority Data
Feb. 13, 2004 (TW) 93103443

(51) Int. Cl. G06K 7/10; G06K 9/22

(52) U.S. Cl. 235/462.14; 235/462.45

(57) ABSTRACT

An automatic scanning device (14) for automatically scanning bar codes attached on products conveyed on production lines includes a sensor (20), two bar code readers (22), an alert lamp (24), a buzzer (26), a halt switch (28), and a hand-held scanner (32). The sensor is used for detecting whether there are products passing through the automatic scanning device. The bar code readers are used for automatically scanning bar codes attached on products when the sensor detects products. The alert lamp and the buzzer are used for timely notifying an operator, the halt switch is used for halting an associated production line or part thereof, and the hand-held scanner is used for scanning the bar codes by hand, when the bar code readers fail to scan the bar codes. A related method is also provided.

### BACKGROUND OF THE INVENTION

1. Field of the Invention

The present invention pertains to devices and methods for scanning bar codes, and particularly to a device and method for automatically scanning bar codes on products conveyed on production lines.

2. Description of Prior Art

Bar code technology is an automated identification technology which is originated and developed from the application of computer technology. Bar code technology provides good inputting speed, accuracy, cost-efficiency and reliability, and is therefore widely used in various commercial fields such as postal services, retail management, storage warehouses, industrial production procedure control, and vehicular traffic and parking lot tolling. In short, bar code technology plays an important role in the area of automated identification technology.

In the fields of industrial production control and industrial automation, systems for automatically scanning bar codes can improve production capacity and efficiency. Systems for automatically scanning bar codes can be used for the following objectives: (i) tracking product quantity and quality: tracking information on product types, production locations, production dates, production lines, product version numbers, batch numbers, and serial numbers; (ii) tracking production dynamically in real time: retrieving production information from computers as soon as the information comes in; (iii) tracking customers: retrieving names, addresses, and product batches of customers from the computers; and (iv) reporting: providing various report forms to operators for auditing. A conventional system for automatically scanning bar codes usually utilizes fixed devices for scanning the bar codes to collect and track information automatically. Each of the fixed devices comprises a support stand for supporting an automatic bar code reader and other components. The fixed devices are respectively located at certain positions on the production line. When products pass through the fixed devices, the automatic bar code readers automatically scan bar codes attached on the products, and send the retrieved bar codes to a client computer through an internal network.

With the ongoing development of manufacturing technology, it is as important as ever that various production devices can be readily adapted for the manufacture of different types or versions of products on a same production line. Conventional fixed devices for scanning bar codes can scan bar codes attached on the same part of the products. In general, different products have various shapes and sizes, and bar codes that represent different information may be attached on different parts of the different products. When the type or version of a product under manufacture changes, or positions of the bar codes on the products change, the fixed devices may fail to properly scan the bar codes. A common solution to this problem is to replace the fixed devices, or change relative positions of scanning components of the fixed devices. However, this adds manufacturing costs, and/or reduces production efficiency.

In addition, any of the fixed devices may fail to properly scan a bar code on a single product for reasons unrelated to the positions of the scanning components of the fixed devices relative to the positions of the bar codes. If this occurs often, an operator cannot efficiently monitor and maintain product manufacturing.

Therefore, there is a need for an automatic scanning device and a method using the automatic scanning devices to automatically scan bar codes attached on products on production lines. It is convenient for the automatic scanning device and the method to scan bar codes attached on different products or on different parts of a same type of products, and can send alert signals to timely notify an operator to scan the bar codes manually when the device fails to scan the bar codes attached on products.

### SUMMARY OF THE INVENTION

A first objective of the present invention is to provide an automatic scanning device and method for conveniently scanning bar codes attached on products conveyed on production lines in order to control and track the products.

A second objective of the present invention is to provide an automatic scanning device and method for conveniently scanning bar codes attached on different products or attached on different parts of a same type of products.

A third objective of the present invention is to provide an automatic scanning device and method for scanning bar codes attached on products, in which alert signals timely notify an operator when automatic scanning of any bar code has failed.

In order to fulfill the above-mentioned objects, the present invention provides an automatic scanning device for scanning bar codes attached on products conveyed on production lines. The automatic scanning device comprises: at least one sensor for automatically detecting whether there are products passing through the automatic scanning device; at least two bar code readers for automatically scanning one or more bar codes attached on the products when said sensors detect that there are products passing through the automatic scanning device; at least one alert device for timely notifying an operator to scan the bar codes manually when said bar code readers fail to scan said bar codes; a halt switch for halting an associated production line or part thereof when said bar code readers fail to scan said bar codes; and a hand-held scanner for scanning said bar codes by hand if necessary.

Further to fulfill the above-mentioned objects, the present invention provides a method for automatically scanning bar codes attached on products conveyed on production lines. The method comprises the steps of: (i) providing an automatic scanning device comprising at least one sensor, at least two bar code readers, at least one alert device, a halt switch, and a hand-held scanner; (ii) detecting whether a products is passing through the automatic scanning device; (iii) automatically scanning one or more bar codes attached on the product if the product is passing through the automatic scanning device; (iv) transmitting an alert signal to said alter device and the halt switch if the automatic scanning device fails to scan said bar codes; (v) scanning said bar codes by using the hand-held scanner; (vi) restarting the production line and returning to step (ii).

Other objects, advantages and novel features of the present invention will become more apparent from the following detailed description when taken in conjunction with the accompanying drawings, in which:

### BRIEF DESCRIPTION OF THE DRAWINGS

FIG. 1 is a block diagram of a production line system incorporating a plurality of automatic scanning devices according to a preferred embodiment of the present invention;

FIG. 2 is an isometric view of a support stand on which an automatic scanning device of FIG. 1 is installed; and

FIG. 3 is a flow chart of a preferred method for automatically scanning bar codes by utilizing one of the automatic scanning devices of FIG. 1.

### DETAILED DESCRIPTION OF THE INVENTION

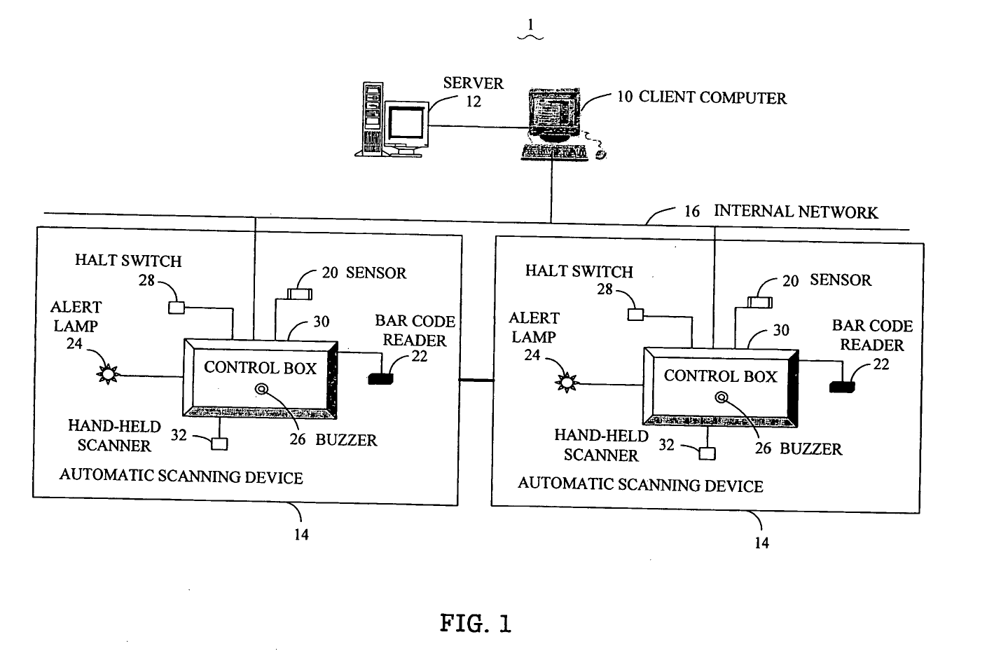

FIG. 1 is a block diagram of a production line system 1 incorporating a plurality of automatic scanning devices 14 (only two shown) of the preferred embodiment of the present invention. The system 1 comprises a client computer 10, a server 12 electronically connected to the client computer 10, and the automatic scanning devices 14. In the preferred embodiment, the system 1 is used on production lines for manufacturing Printed Circuit Boards (PCBs). Once the production lines are started up, they run at a predetermined speed. The client computer 10 communicates with the automatic scanning devices 14 via an internal network 16 in order to monitor the production lines.

The client computer 10 is used for receiving bar code data from the automatic scanning devices 14, and displaying human-readable bar code information that is converted from the bar code data. The client computer 10 also receives instructions input by an operator via an input device such as a keyboard or a mouse of the client computer 10. For example, the operator can input an instruction to complete scanning. The server 12 has a plurality of applications installed therein for managing and controlling various devices in the system 1. The server 12 also comprises a storage device (not shown) for storing the bar code data.

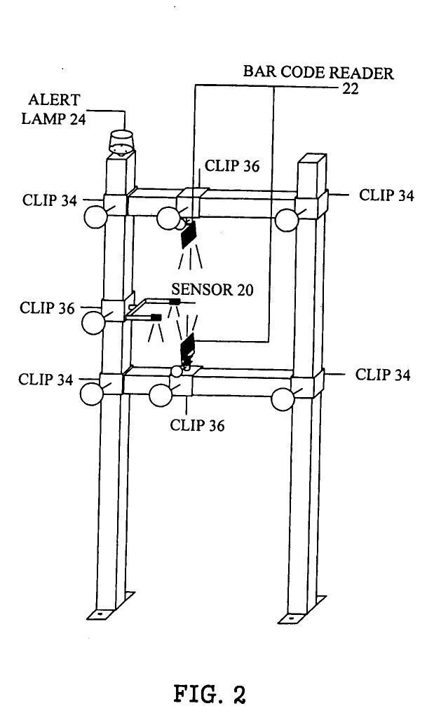

The automatic scanning devices 14 are used for scanning bar codes attached on PCBs, when the PCBs pass through the automatic scanning devices 14. Each of the automatic scanning devices 14 is fixed at a certain location on the production lines, and comprises a sensor 20, two bar code readers 22 (only one shown), an alert lamp 24, a buzzer 26, a halt switch 28 electronically connected to a console (not shown) that controls the production lines, and a hand-held scanner 32. The above-mentioned components of the automatic scanning device 14 are assembled on a same support stand (described in detail below in relation to FIG. 2), and communicate with each other through data buses installed in a control box 30. In alternative embodiments, the automatic scanning device 14 comprises more than one sensor 20 and/or more than two bar code readers 22.

The sensor 20 is used for automatically detecting whether there is a PCB passing through the automatic scanning device 14. If a PCB passes through the automatic scanning device 14, the sensor 20 transmits a sense signal to the bar code readers 22. Then, one of the bar code readers 22 scans a certain bar code attached on the PCB. In alternative embodiments, the bar code reader 22 scans various bar codes attached on the PCB.

Each of the bar code readers 22 contains an automatic scanner and a controller (not shown). The automatic scanner is provided for scanning bar code attached on a PCB when the bar code reader 22 receives the sense signal from the sensor 20, and for transmitting the bar code data to the client computer 10 via the internal network 16. If the automatic scanner of the bar code readers 22 fails to scan the bar code attached on the PCB, the controller sends a failure signal simultaneously to the alert lamp 24, the buzzer 26, and the halt switch 28 via the data buses in the control box 30. Accordingly, the alert lamp 24 lights up, the buzzer 26 sounds, and the halt switch 28 halts the production line, thereby notifying an operator to timely deal with the situation. At this time, the operator scans the bar code by using the hand-held scanner 32. The hand-held scanner 32 sends the bar code data to the client computer 10 through the internal network 16, and sends a restart signal to the halt switch 28. The halt switch 28 then restarts the production line.

FIG. 2 is an isometric view of a support stand with an automatic scanning device 14 installed thereon. The components of the automatic scanning device 14 are mechanically connected to the support stand. The support stand comprises two vertical posts and two horizontal posts. Each of the horizontal posts has a scale for accurately positioning a corresponding bar code reader 22 thereon. There are four clips 34 fixed on the four posts for interconnecting the posts, and several clips 36 fixed on various of the posts for fixing the components of the automatic scanning device 14 thereon. The clips 34 can be used for adjusting the elevations of the horizontal posts. The clips 36 can be used for adjusting the positions of the components of the automatic scanning device 14 on the posts. In the preferred embodiment, only positions of the bar code readers 22, the sensor 20, and the alert lamp 24 play an important role in scanning of the bar codes. Therefore, only the bar code readers 22, the sensor 20, and the alert lamp 24 are shown in FIG. 2.

The alert lamp 24 is positioned on top of one of the vertical posts, so that the alert lamp 24 is easily noticed by an operator when it lights up. The sensor 20 is located on one of the vertical posts, between the horizontal posts. Thus when a conveyer runs through the space between the horizontal posts, the sensor 20 can detect whether there is a PCB on the conveyer passing through the automatic scanning device 14. Because the bar codes of different PCBs may be attached on different parts of the PCBs, the two bar code readers 22 are fixed on each of the horizontal posts, with the automatic scanners of the bar code readers 22 facing each other. In the preferred embodiment, the conveyer is hollow, and the PCBs are placed therein. Usually, the bar codes for each kind of PCBs are attached on a same surface of the PCBs; that is, the bottom surface or the top surface. Therefore, in general, only one of the bar code readers 22 is used for scanning the bar codes when PCBs pass through the automatic scanning device 14. The position of each bar code reader 22 on the horizontal post can be accurately adjusted according to the scale by moving the corresponding clip 36. Thus, even when the PCBs have different sizes, or the bar codes are attached on different parts of the PCBs, one of the bar code readers 22 can scan the bar codes attached on the PCBs. The automatic scanner of each bar code reader 22 can be rotated in a horizontal plane over a range of 90 degrees. Thus, even when the orientation of the bar codes changes, the operator can rotate the automatic scanners accordingly to scan the bar codes. In an alternative embodiment, if the bar codes are attached on side surfaces of products, each of the vertical posts has a scale for accurately positioning a corresponding bar code reader thereon, the bar code readers 22 are fixed on the vertical posts, and the automatic scanner of each bar code reader 22 can be rotated in a vertical plane over a range of 90 degrees.

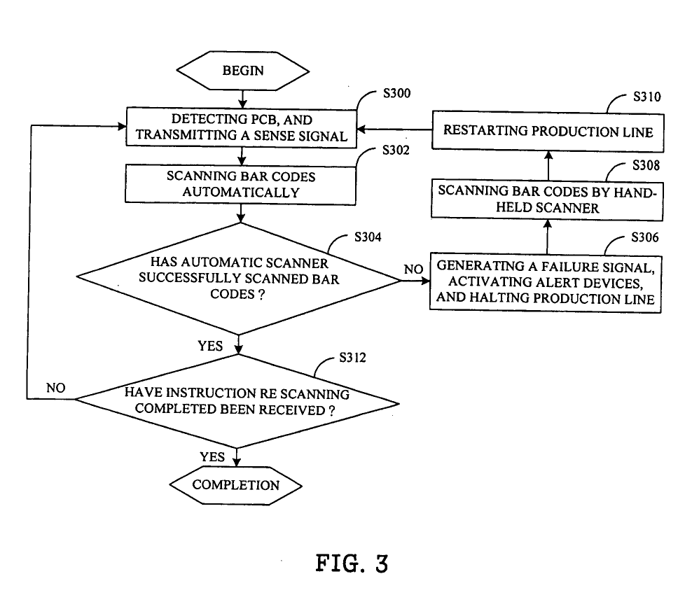

FIG. 3 is a flowchart of the preferred method for automatically scanning bar codes attached on PCBs by utilizing one of the above-described automatic scanning devices 14. First, the production lines are started up, and the system 1 is initiated. At this time, the positions of the bar code readers 22 on the horizontal posts of the support stand may need to be adjusted in order to ensure that one of the bar code readers 22 is able to scan the bar codes attached on the PCBs. This is done by adjusting the clips 36 and the clips 34. In general, the bar codes are attached on a same surface of the PCBs, so that only one bar code reader 22 is used for scanning the bar codes. When the system 1 is operating, if the orientation of the bar codes attached on the PCBs changes, the automatic scanner of the bar code reader 22 needs to be rotated so that the bar code reader 22 can scan the bar codes. At step S300, when a PCB passes through the automatic scanning device 14, the sensor 20 detects the PCB, and transmits a sense signal to the bar code reader 22 through the data buses in the control box 30. At step S302, the automatic scanner of the bar code reader 22 automatically scans the bar code attached on the PCB.

At step S304, the bar code reader 22 determines whether the automatic scanner thereof has successfully scanned the bar code. If the automatic scanner has successfully scanned the bar code, the procedure goes to step S312 described below. If the automatic scanner has failed to successfully scan the bar code, at step S306, the controller of the automatic scanning device 14 generates a failure signal, and transmits the failure signal to the alert light 24, the buzzer 26, and the halt switch 28 simultaneously via the data buses in the control box 30. The alert light 24 lights up, the buzzer 26 sounds, and the halt switch 28 halts the production line, thereby notifying an operator of the need to scan the bar code manually. At step S308, the operator uses the hand-held scanner 32 to scan the bar code attached on the PCB. The hand-held scanner 32 then transmits the bar code data to the client computer 10, and sends a restart signal to the switch 28. At step S310, the switch 28 restarts the production line and the conveyer resumes running, whereupon the procedure returns to step S300 described above regarding a next PCB passing through the automatic scanning device 14.

At step S312, the server 12 determines whether the client computer 10 has received operator-input instructions that the scanning of PCBs is completed. If the client computer 10 has received such instructions, the server 12 transmits a completion signal to the halt switch 28, and the production line is halted. If the client computer 10 has not received such instructions, the procedure returns to step S300 described above regarding a next PCB passing through the automatic scanning device 14.

While a preferred embodiment and method of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

1. An automatic scanning device for bar codes, comprising:
at least one sensor, for automatically detecting whether there are products passing through the automatic scanning device;
at least two bar code readers, for automatically scanning one or more bar codes attached on the products when said sensor detects that there are products passing through the automatic scanning device;
at least one alert device, for notifying an operator when any of said bar code readers fails to scan said bar codes;
a halt switch, for halting an associated production line or part thereof when any of said bar code readers fails to scan said bar codes; and
a hand-held scanner, for scanning said bar codes by hand if necessary.

2. The automatic scanning device as recited in claim 1, wherein said sensor, said bar code readers, said alert device, the halt switch and the hand-held scanner are assembled on a same support stand, and communicate with each other through data buses in a control box also on the support stand.

3. The automatic scanning device as recited in claim 2, wherein the support stand comprises two vertical posts and two horizontal posts.

4. The automatic scanning device as recited in claim 3, wherein said bar code readers are separately fixed on two opposite of the posts.

5. The automatic scanning device as recited in claim 4, wherein said bar code readers are fixed on the posts by clips.

6. The automatic scanning device as recited in claim 5, wherein the clips adjustably position said bar code readers on the posts.

7. The automatic scanning device as recited in claim 4, wherein said bar code readers can be rotated for scanning said bar codes according to different orientations thereof.

8. The automatic scanning device as recited in claim 1, wherein said alert device comprises an alert lamp.

9. The automatic scanning device as recited in claim 1, wherein said alert device comprises a buzzer.

10. A method for automatically scanning bar codes attached on products conveyed on a production line, the method comprising the steps of:
(a) providing an automatic scanning device comprising at least one sensor, at least two bar code reader, at least one alert device, a halt switch, and a hand-held scanner;
(b) detecting whether a product is passing through the automatic scanning device;
(c) automatically scanning one or more bar codes attached on the product if the product is passing through the automatic scanning device;
(d) transmitting an alert signal to said alert device and the halt switch if the automatic scanning device fails to scan said bar codes;
(e) scanning said bar codes by using the hand-held scanner;
(f) restarting the production line, and returning to step (b).

11. The method as recited in claim 10, wherein said alert device comprises an alert lamp.

12. The method as recited in claim 10, wherein said alert device comprises a buzzer.

13. A method for automatically scanning a bar code attached on a conveyed product, comprising the steps of:
sensing passage of said conveyed product through a predetermined location;
providing at least two bar-code readers around said predetermined location to establish a scanning coverage for said bar code on an essentially overall profile of said product; and
automatically scanning said bar code to generate product information related to said product.

14. The method as recited in claim 13, further comprising the step of generating an alert signal to an alert device in case that none of said product information is available in said scanning step.

15. The method as recited in claim 13, wherein two of said at least two bar-code readers are installed at two opposing sides of said predetermined location via a support stand.
